(19) United States
(12) Patent Application Publication
(10) Pub. No.: US 2008/0286422 A1
(43) Pub. Date: Nov. 20, 2008

(54) Method and Apparatus for Producting Blocks of Cheese

(76) Inventors: Rista Brkovic, Victoria (AU); Aaron Chandler, Hamilton (NZ); Christo Andre De Klerk, Albany (NZ)

Correspondence Address: YOUNG & THOMPSON, 209 Madison Street, Suite 500, ALEXANDRIA, VA, 22314, US

(21) Appl. No.: 11/664,067

(22) PCT Filed: Jul. 7, 2005
(86) PCT No.: PCT/NZ05/00159

§ 371 Date: May 30, 2007

(30) Foreign Application Priority Data
Jul. 7, 2004 (NZ) 533971

(51) Int. Cl. A01J 27/00

(52) U.S. Cl. 426/130; 53/434

(57) ABSTRACT

Apparatus for producing cheese blocks. The apparatus includes a cheese former for forming blocks of cheese. A plurality of moulds formed by a base (40) and lid (41). A loading station (20) in which a bagged block of cheese (14) is engaged in a mould base (40) and then enclosed by a lid (41). The bagged blocks of cheese in the moulds (40, 41) are then conveyed to a cooler for rapid cooling. Following this the moulds are moved to an unload station whereupon the blocks of cheese are removed from the moulds.

### BACKGROUND TO THE INVENTION

This invention relates to a method and apparatus for producing blocks of cheese.

In the production of cheddar cheese, and similar types of cheese, it is known to use a so-called block former to form curd pieces into blocks of cheese. Curd chips are loaded into the former, which usually is a column or tower. The curd chips are consolidated in the tower and whey is drained from the tower. At the lower end of the tower a horizontally operable blade is positioned so as to cut a block of so-called “green cheese” from the consolidated column.

Once the blade has moved to its fully cutting position, it supports the lower end of the pillar of curd in the tower. A gate or the like (on which the pillar is normally supported) can move away (generally downwardly) so as to move the cut block of green cheese out of the tower. The block is then placed in a bag, usually a plastic bag, e.g. one made of polyethylene, and the bag is subjected to sub-atmospheric pressure and sealed. The thus packed block is then placed in a carton and the carton containing the cheese is then conveyed away to a storage room to ripen.

The block, when it exits the machine, is fragile and can be unstable. By placing the bagged cheese block into a carton it has been found that the carton tends to provide the necessary stability to the block and also protect it from damage. However, once a vacuum has been pulled in the bag the block can tend to slump and be “out of square”. This can present a problem later on from a perceived quality point of view. For example, when the block is to be cut into smaller blocks, the smaller blocks which have one or more surfaces corresponding to the external surface of the original block, may be surfaces which are not entirely flat or square to the other surfaces of the cut block.

In addition, the use of the carton represents a cost to the producer not only in the cost of the carton itself but also in costs associated with handling, storage, erection and closure processing of a multitude of cartons. Therefore, if the need for a carton can be removed there would be advantages to the cheese producer.

### SUMMARY OF THE INVENTION

It is, therefore, an object of the present invention to provide a method and apparatus whereby cartonless production of cheese can be achieved.

Broadly according to one aspect of the present invention there is provided a method of producing a cheese block, the method including the steps of forming cheese in a cheese former, creating a block of cheese therefrom, placing the block in a bag, engaging the bagged block in a mould and placing the mould in a rapid cooler.

In a second broad aspect of the invention there is provided apparatus for producing cheese blocks, the apparatus including means for forming blocks of cheese, a plurality of moulds, a loading station in which a bagged block of cheese is engaged in a mould, transfer means to transfer moulds containing cheese blocks to a cooler and an unload station to remove the blocks of cheese from the moulds.

### BRIEF DESCRIPTION OF THE DRAWINGS

In the following more detailed description of the invention, according to one preferred embodiment, reference will be made to the accompanying drawings in which:—

FIG. 1 is an elevation view of a cheese block mould for use in the apparatus,

FIG. 2 is a plan view of the base,

FIG. 3 is an end elevation of the base,

FIG. 4 is a side elevation view of a lid of the mould,

FIG. 5 is a plan view of the lid,

FIG. 6 is an end elevation of the lid,

FIG. 7 is a plan view of the layout of apparatus of the invention embodied in a facility for producing cheese blocks,

FIG. 8 is a perspective illustration of a load station forming part of the apparatus of FIG. 7,

FIG. 9 is an elevation view in somewhat schematic form of an inverter forming part of the apparatus of FIG. 7, and

FIG. 10 is a end view of the arrangement shown in FIG. 9.

### DETAILED DESCRIPTION OF PREFERRED EMBODIMENTS OF INVENTION

As will be evident from the following disclosure the present invention is based on the concept of placing a block of “green cheese”, once it has issued from a cheese former, into a plastic bag. The bag will then be placed in a vacuum packaging machine so that sub-atmospheric pressure is applied to the interior of the bag. The bag is then sealed.

According to the invention the thus bagged block will be placed in a mould (as herein described) to maintain the bagged block shape and the block and mould combination will be placed in a rapid cool store for a period of time. Following this the moulds will be removed (for reuse) and the bagged cheese blocks then placed in a cool store for ripening.

Thus, in line with this concept, there will hereinafter be described a preferred form of a two-piece mould and the layout of a plant showing the procedure between the forming of cheese, in a block former, and the final packaged cheese block being placed into a cool store for ripening of the cheese to occur prior to transportation or further handling.

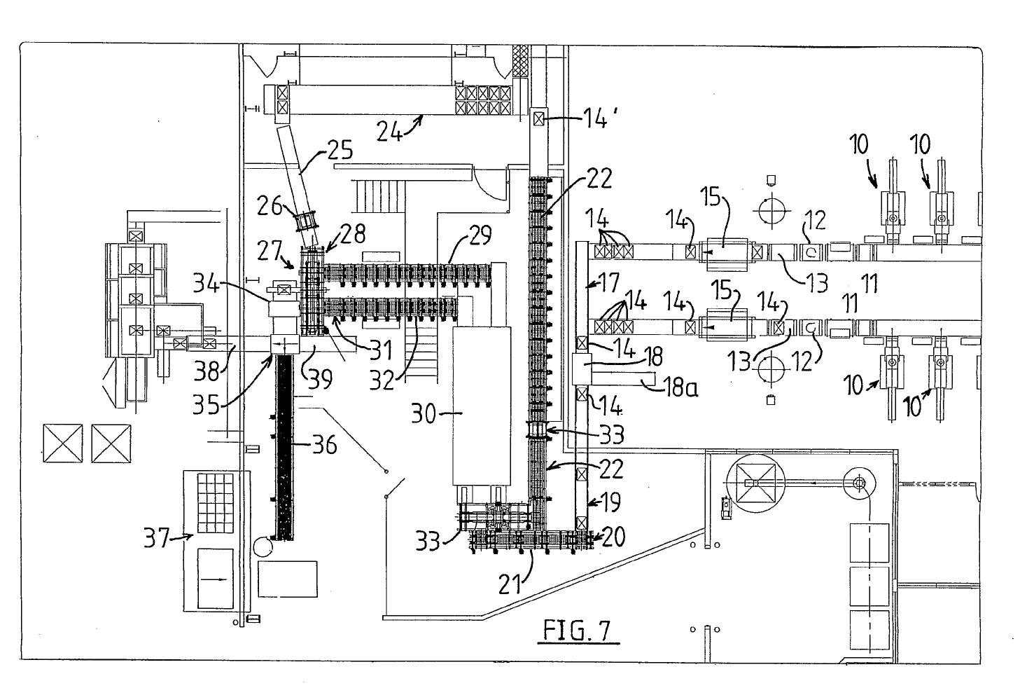

Referring to firstly FIG. 7, the plant includes one but preferably a plurality of cheese towers or block formers 10. The block former 10 can be of known construction and, therefore, for the purposes of describing the present invention, further description is not required.

According to the present invention, a block of “green cheese” issuing from the block former 10 is packaged in a plastic bag and conveyed by a conveyor system 11 (which may include a reorientation conveyor 12) to an input conveyor 13 whereby the bagged block 14 is placed in a vacuum packaging machine 15 such as a Betavac®.

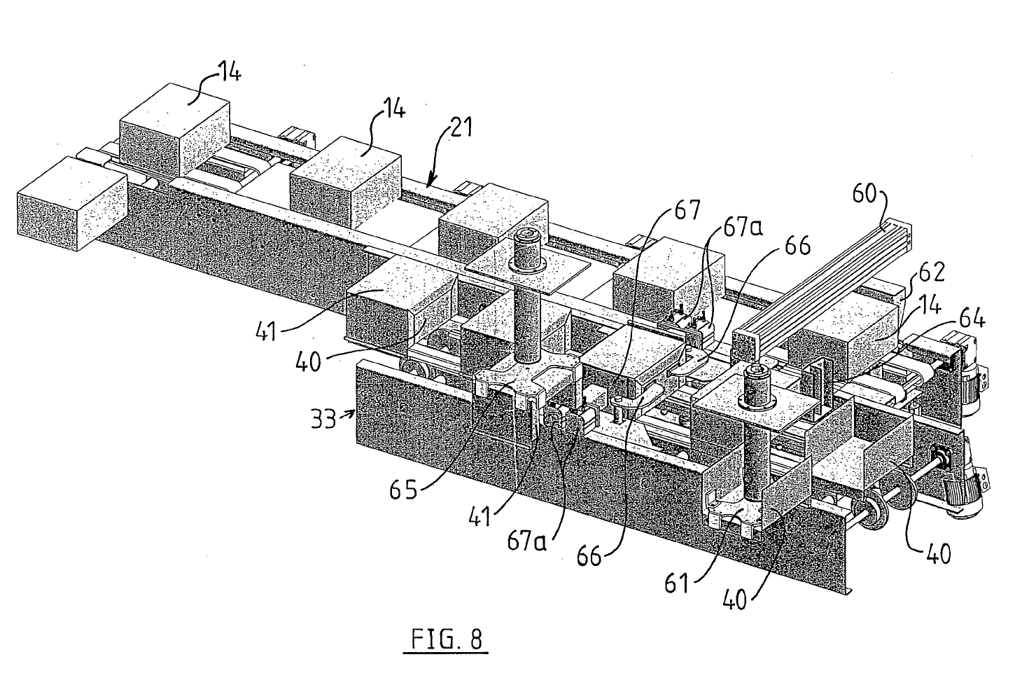

The thus, evacuated and sealed bag of cheese 14 is then conveyed by a conveyor 16 onto a feed conveyor 17. The block passes through an auto-check weigh station 18 (and associated reject conveyor 18a) to ultimately end up at a load station 20. At the load station 20 the bagged cheese block 14 is placed in a mould, the construction and operation of which will hereinafter be described with reference to FIG. 8.

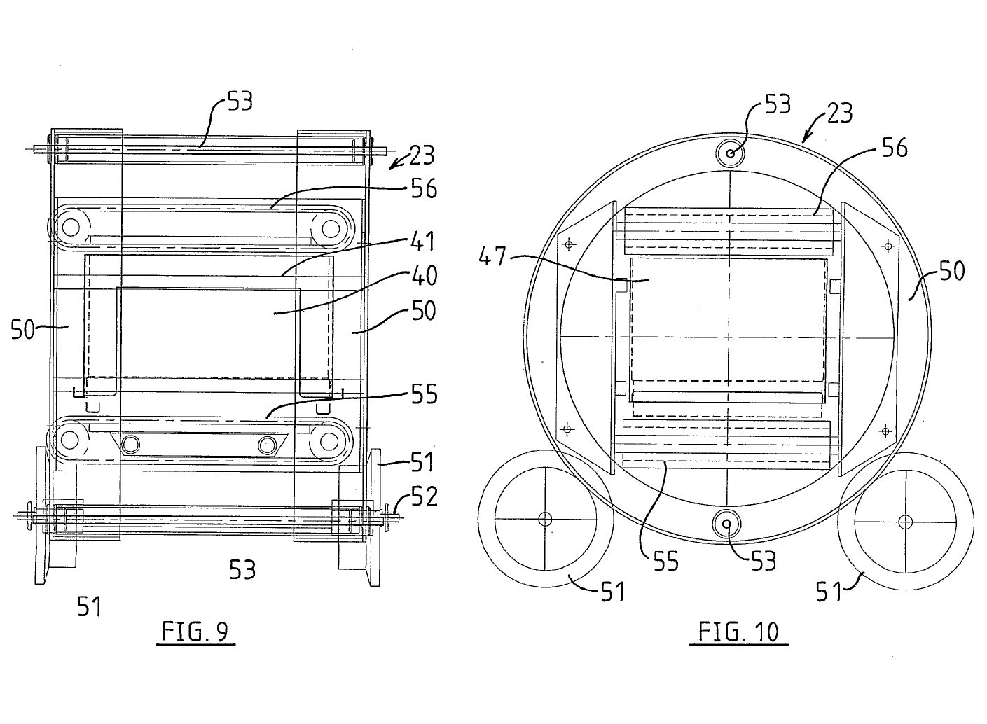

The cheese block in its mould is conveyed through the load station 20 to a span conveyor 22, which conveys the mould and its cheese block 14¹ to a rapid cooler 24. In the length of the span conveyor 22 there is an inverter 23 (see FIGS. 9 and 10) which inverts the mould and cheese combination 14¹.

The inverting of the mould enables the cheese block in the mould to “reshape” within the mould in the event that there has been any slumping of the green cheese. It will be evident to those skilled in the art that different means of inverting the mould can be used but one possible arrangement is shown in FIGS. 9 and 10 the construction and operation of which will hereinafter be described.

The cheese blocks, in their moulds, are retained in the rapid cool store 24 for say 16-24 hours whereupon the cheese block and mould is conveyed, via e.g. a de-elevating conveyor 25 through an inverter 26 to an unload station 27.

At the unload station 27 the mould and cheese block first pass through a lid manipulator station 28, at which the lid of the mould is removed and placed on a conveyor 29 which conveys the lid to a washing machine 30. Likewise, at a base manipulator station 31 the base of the mould is removed from the cheese block and moved via conveyor 32 to the washing machine 30.

After passing through the washing machine 30 the lids and bases of the moulds exit onto an indexing conveyor 33 ready for assembly about a cheese block 14 at the load station 20.

The cheese block 14 removed from its mould is conveyed via a metal detector/X-ray machine 34 to a leak testing device and associated three-way transfer station 35. The cheese block 14 can then be conveyed via a collating belt conveyor 36 for pallet loading and storage in cool store 37. It can also be conveyed by conveyor 38 to a conventional cardboard carton loading station. Alternatively, it can proceed via conveyor 39 if rejected at the leak testing and transfer station 35.

The foregoing provides one example of a plant whereby a cheese block formed, in a block former 10, can be processed without the need for a cardboard carton. Thus, a complete cartonless cheese block handling system is provided.

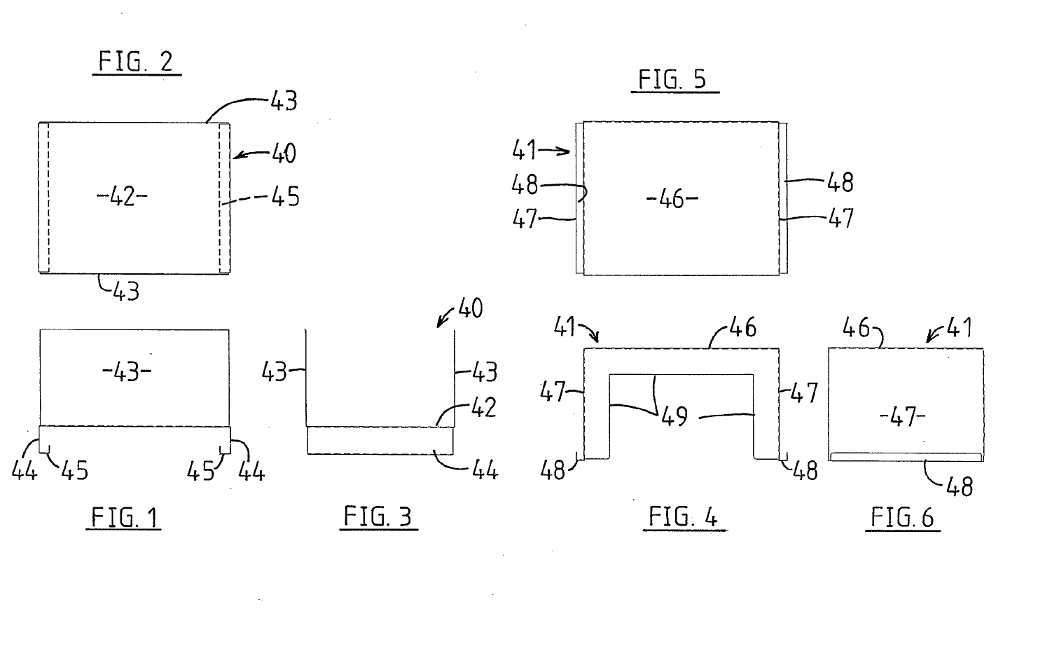

As described, an essential component of the system is the use of a mould for retaining the bagged cheese block after vacuum packaging, and through to the unload station. A preferred form of two-piece stainless steel mould is illustrated in FIGS. 1-6 to which reference is now made.

The mould comprises a base unit 40 and a lid unit 41. The base comprises a floor, which in plan view is of a shape commensurate with the shape of one side of the cheese block. Projecting from opposed sides of the floor 42 is a pair of upstanding parallel walls 43.

In the preferred form of the invention the base 42 has a pair of downwardly projecting sidewalls 44 which project from the other two ends of the floor 42. Each wall is provided at its lower end with a return portion 45 which provides a strong and stable foot support for the floor 42. Also the return positions 45 provide a means for engagement with a conveyor and stabilising the base unit 40 on a conveyor.

The lid 41 is of generally U-shape providing a cover 46 and a pair of opposed downwardly projecting walls 47. The lower end of each wall 47 is provided with a lipped form 48 to provide strengthening for the lower end of the wall.

The return portion 45 and lipped form 48 also profile gripping areas for handling of the mould sections, the assembled mould and disassembly of the mould.

A skirt 49 which is generally of U-shaped extends inwardly and downwardly from the edges of the cover 46 and sidewalls 47 (see FIG. 4).

The base is configured and dimensioned such that the bagged cheese block can be loaded into the base so as to fit snugly between the end walls 43 and be supported on the floor 42. With the cheese block in position on the base the lid 41 is placed over the cheese block and base 40 so that the remaining exposed top side and the other end surfaces of the bagged cheese block are located adjacent the inside surface of the cover 46 and the end walls 47 respectively.

FIG. 8 illustrates a load station suitable for handling incoming bagged cheese blocks 14 and then placing these into the base unit 40 and lid 41.

As shown in the drawing the bagged blocks of cheese 14 advance along an indexing conveyor 21. A base unit 40 of a mould is transported from the washing machine 30 to the indexing conveyor 33.

In the illustrated form of the invention a pistonless linear actuator 60 moves a grab unit 61 into position and places the base unit 40 on the indexing conveyor 33. The base unit 40 is then indexed to a block loading position whereupon a pusher 62 pushes the block of cheese 14 into the base unit 40. Guide elements 64 can be provided between the indexing conveyors 21 and 33 so as to ensure that the block 14 moves correctly off the indexing conveyor 21 and into the base unit 40.

The return portions 45 of the base unit 40 engage with the indexing conveyor 33 in such a manner that movement of the base unit 40 is prevented when the block of cheese is pushed therein by pusher 62.

The base unit 40 and cheese block 14 then advances to a lid application position. As can be seen in FIG. 8 a similar arrangement (though the pistonless actuator is not shown) is used where a clamping unit 65 clamps a lid unit 41 and moves this across to a position where it can be placed onto the base unit. To facilitate this, a pair of clamp arms 66 on each side of the base unit 40 are actuated and come into contact with the sidewalls 43 of the base unit 40. The effect of these clamp arms 66 is to push the wall 43 in slightly so as to provide a clearance for positioning of the lid 41 onto the base 40.

Prior to the lid 41 being lowered onto the base unit 40 a pair of cylinders 67a operate a pusher plate 67. This applies pressure to the end of the cheese block so as to push the end of the cheese block inwardly and, once again, create a clearance to enable correct positioning of the lid 41 onto the base 40. This pusher plate retracts just prior to the lid 41 descending onto the base unit 40.

The above described manipulation of the bagged cheese block in the base unit 40 enables an irregular object (the cheese block) to be given repeatable shape and dimensions. While it is the mould which provides the regular shape and dimensions the guides 64 can function as a squeezing gate to ensure that the block fits into the base unit 40 without damages, takes out wrinkles in the plastic bag, helps define edges and removes “crocodile skin”. In addition there is the compression of the cheese block by clamps 66 and pusher plates 67 that aid the shaping as well as allow the lid unit 41 to be applied to base 40.

The squeezing of the cheese block during the insertion process allows additional forces to be exerted on the cheese providing more force to re-shape the block.

The bagged cheese block is thus fully located within the assembled mould. The mould is then indexed along the indexing conveyor 33 until it reaches the span conveyor 22. In the length of the span conveyor 22 is the inverter 23.

Essentially the inverter includes a pair of ring elements 50 that are mounted for rotation on two pairs of wheels 51 supported by axles 52. The annular or ring elements 50 are joined together and held in a spaced apart array by tyre rods 53.

Spanning between the annular elements 50 mounted by mounting plates 54 is a pair of endless conveyor belts 55 and 56. The space between the conveyor belts 55 and 56 is such that a mould can be accommodated therebetween as is shown in FIGS. 9 and 10.

In use, a mould is advanced by a feed-in conveyor and drawn into the inverter 23 by the lower conveyor 55. The conveyor 55 ceases operation when sensors sense that the mould is located within the inverter. The wheels 51 are then driven to rotate the assembly through 180°, this rotation being about the central longitudinal axis of the assembly. This results in the mould being inverted whereupon the conveyor 56 operates to move the inverted mould out onto a feed-out conveyor and, as shown in FIG. 7, moved to the rapid cooler 23.

The inverter remains in this orientation for the next incoming mould whereupon it then rotates through 180° and the now lower most conveyor 55 operates to feed-out the mould onto the out feed conveyor. The inverter apparatus is simple, yet effective in operation, and is readily integrated into the span conveyor 22. It will be appreciated from the foregoing that the span conveyor 22 is in two parts, one forming the in-feed conveyor to the inverter 23 and the other the out-feed conveyor which leads to the rapid cooler 24.

The mould arrangement ensures that any tendency for the green cheese block to be “out of square” is restored by the engagement of the surfaces of the floor 42, cover 46 and sidewalls 43 and 47 in order to “mould” the bagged block into a squared up block configuration. After the rapid cooling stage the bagged cheese block has ripened sufficiently to stabilise the block and largely remove its fragility. Thus the block, even though only contained in a bag, has sufficient integrity that it can be further handled and placed in the cool store for further ripening.

Not only does the method and apparatus according to the present invention remove the need for the cheese block to be located within a carton, it is believed that the physical quality (e.g. shape and dimensions) of the block will be optimised. Consequently, the block will have flat surfaces but also well defined corners and edges.

It will be appreciated by those skilled in the art that essentially the present invention is directed to production of 20 kg blocks of cheese. Nevertheless, the present invention is suitable for use with other sized blocks issuing from a block former or, indeed, cut from blocks issuing from a block former.

The invention, therefore, provides for the block of “green cheese” to be placed in a bag, evacuated and then placed in a mould so that the mould and cheese combination can be placed in a rapid cooler for a suitable period of time. After the block has ripened sufficiently to be self-supporting it can be handled in the normal manner for further ripening in a cool store and then transported or placed in storage for future use.

1. A method of producing a cheese block, the method including the steps of forming cheese in a cheese former, creating a block of cheese therefrom, placing the block in a bag, engaging the bagged block in a mould and placing the mould in a rapid cooler.

2. The method of claim 1 wherein the block of cheese is vacuum packed in the bag.

3. The method of claim 1 or 2 wherein the bagged block is placed in a base unit of a mould and a lid is placed thereover such that the bagged block is fully encased by the combination of the base unit and lid.

4. The method of any one of claims 1 to 3 wherein compressive forces are applied to the bagged block when the bagged block is located in at least a part of the mould.

5. The method of any one of claims 1 to 4 wherein compressive forces are applied to the bagged block as it is placed into at least part of the mould.

6. The method of claim 4 wherein the compressive forces are at least in part applied via the application of a force to said part of the mould.

7. The method as claimed in any one of the proceeding claims wherein the mould with enclosed bagged block of cheese is inverted prior to undergoing rapid cooling.

8. The method according to any one of the proceeding claims wherein the mould with enclosed bagged block of cheese is retained in the rapid cooler for a period of between about 16-24 hours.

9. The method according to claim 7 or 8 wherein the mould with enclosed bagged block of cheese is inverted after conclusion of the rapid cooling stage.

10. The method according to any one of the preceding claims wherein following the rapid cooling stage the bagged block of cheese is removed from the mould.

11. A method of producing a cheese block as claimed in claim 1 substantially as herein described with reference to FIGS. 1-7 of the accompanying drawings.

12. Apparatus for producing cheese blocks, the apparatus including means for forming blocks of cheese, a plurality of moulds, a loading station in which a bagged block of cheese is engaged in a mould, transfer means to transfer moulds containing cheese blocks to a cooler and an unload station to remove the blocks of cheese from the moulds.

13. Apparatus as claimed in claim 12 further including vacuum bagging apparatus for vacuum packing the blocks of cheese into bags.

14. Apparatus as claimed in claim 12 or 13 wherein the loading station includes indexing means for indexing bagged blocks of cheese into the moulds.

15. Apparatus as claimed in claimed in claim 14 wherein the loading station includes a pair of contra moving indexing conveyors and pushing means for pushing a bagged block of cheese from one indexing conveyor to a mould part located on the other indexing conveyor.

16. Apparatus as claimed in claim 15 further including guide means to guide the bagged block of cheese into the mould part.

17. Apparatus as claimed in claim 16 wherein the guide means is arranged to apply a squeezing action to the bagged block of cheese as it passes therethrough.

18. Apparatus as claimed in claim 15, 16 or 17 further including pick and place means for placing a second mould part over a first mould part containing a bagged block of cheese.

19. Apparatus as claimed in claim 18 including pressure applying means to apply pressure to the mould part and contained bagged block of cheese prior to application of the second mould part.

20. Apparatus as claimed in any one of the preceding claims 12-19 further including an inverter for inverting a mould containing a cheese block prior to transferring mould with contained cheese block to the cooler.

21. Apparatus as claimed in claim 20 wherein the inverter includes a pair of conveyors spaced apart such that a mould containing cheese block can locate therewith.

22. Apparatus as claimed in claim 21 wherein the conveyors are mounted by rotatable support means.

23. Apparatus as claimed in any one of claims 12 to 22 further including an inverter for inverting a mould containing a cheese block after movement thereof from the cooler.

24. Apparatus as claimed in any one of the preceding claims further including transfer means for transferring mould from the unload station to a washing apparatus.

25. Apparatus as claimed in claim 24 wherein the transfer means includes a first transfer means for handling a first mould part and a second transfer means for handling a second mould part.

26. Apparatus as claimed in any one of the preceding claims further including one or more of a metal detector and leak testing device through which a bagged block of cheese removed from an unload station is processed.

27. Apparatus for producing cheese blocks substantially as herein described with reference to FIG. 7 of the accompanying drawings.
